(19) United States
(12) Patent Application Publication
(10) Pub. No.: US 2019/0278095 A1
(43) Pub. Date: Sep. 12, 2019

(54) FOLDABLE LIGHT BOX

(71) Applicant: DISPLAY CHOICE LLC, Succasunna, NJ (US)

(72) Inventor: Guojun PAN, Shanghai (CN)

(73) Assignee: DISPLAY CHOICE LLC, Succasunna, NJ (US)

(21) Appl. No.: 15/912,779

(22) Filed: Mar. 6, 2018

(51) Int. Cl. G02B 27/04; G09F 13/04; F21V 17/00; F21V 15/01; F21V 7/00

(52) U.S. Cl. CPC G02B 27/04; G09F 13/0413; G02B 27/024; F21V 15/012; F21V 7/005; F21V 17/007

(57) ABSTRACT

A foldable light box, including fourth profiles. The fourth profiles are assembled into a frame structure through profile connectors. The inner side walls of the fourth profiles at the upper end and the lower end of the frame structure are connected with lamp bead profiles. The inner side walls of the lamp bead profiles are stuck with LED lamp bead parts through a thermally conductive adhesive. The folding function of the entire light box is achieved by the cooperation of the foldable mechanism and the meshing mechanism provided by the present utility model. As the size is reduced, the light box is more convenient to place and transport, needs less transportation cost and space, and is more convenient to carry and display.

### FIELD

The present utility model belongs to the technical field of light boxes, and particularly relates to a foldable light box.

### BACKGROUND

Light boxes, as image viewing boxes for X-ray image examination, are generally formed by light sheets, and favorably by PC boards which are resistant to the highest temperature of 145° C., and the lowest temperature of −55° C. According to the materials used, the light boxes are divided into ultrathin light boxes, plastic-absorbing light boxes, rolling light boxes, crystal light boxes, fabric light boxes, electronic light boxes, EL light boxes, LED light boxes, acrylic light boxes, aluminum profile light boxes, glass fiber reinforced plastics light boxes, stainless steel light boxes, etc. However, the existing light boxes are difficult to transport and place as their sizes are large. This problem needs to be solved.

### SUMMARY

An object of the present utility model is to provide a foldable light box so as to solve the problem in the prior art that the existing light boxes are difficult to transport and place as their sizes are large.

In order to achieve the above object, the present utility model provides the following technical solution. A foldable light box includes fourth profiles which are assembled into a frame structure through profile connectors. The upper surface of the fourth profile is connected with a first profile and a foldable mechanism. The outer side surface of the fourth profile at the left end of the frame structure is connected with a second profile. The outer side surface of the fourth profile at the right side of the frame structure is connected with a third profile. The second profile and the third profile are meshed with each other by a meshing mechanism. The inner side walls of the fourth profiles at the upper and lower ends of the frame structure are connected with lamp bead profiles. The inner side walls of the lamp bead profiles are stuck with LED lamp bead parts by a thermally conductive adhesive. The LED lamp bead parts are electrically connected with an external power supply. U-shaped grooves are formed in the outer side walls of the second profile, the third profile and the fourth profile.

Preferably, the foldable mechanism consists of a tension spring fixing block, a tension spring, a sliding block, a chain and a chain fixing block.

Preferably, there is a set of meshing mechanism respectively arranged on the upper and lower surfaces of the second profile and of the third profile when the second and third profiles are meshed. The meshing mechanism consists of two limiting and fixing levers on the second profile and the third profile.

Preferably, a reflective fabric is arranged on one side surface of the frame structure. A stretched fabric is arranged on the other side surface of the frame structure. The reflective fabric and the stretched fabric are embedded in the U-shaped grooves in the outer side surfaces of the second profile, the third profile and the fourth profile through a silica gel strip.

Preferably, there are patterns printed on the surface of the stretched fabric.

Compared with the prior art, the beneficial effects of the present utility model are as follows. The structure of the present light box is more scientific and reasonable, and thus the light box is safer and more convenient to use. The folding function of the entire light box is achieved through the cooperation of the foldable mechanism and the meshing mechanism. As the size is reduced, the light box is more convenient to place and transport. The transportation cost and space are reduced, so that the light box is more convenient to carry and display. Therefore, the present light box is more competitive, can realize side lighting and back lighting, and is more flexible to use.

### BRIEF DESCRIPTION OF THE FIGURES

FIG. 1 is a schematically structural view of a foldable light box provided by the present utility model during side lighting;

FIG. 2 is a schematically structural view of a foldable mechanism provided by the present utility model;

FIG. 3 is a partial enlarged view of the A part in FIG. 1; and

FIG. 4 is a schematically structural view of the foldable light box provided by the present utility model during back lighting.

Description of the reference numerals in the figures: 1—foldable mechanism; 11—tension spring fixing block; 12—tension spring; 13—sliding block; 14—chain; 15—chain fixing block; 2—fourth profile; 3—first profile; 4—LED lamp bead part; 5—third profile; 6—second profile; and 7—meshing mechanism.

### DETAILED DESCRIPTION OF THE FIGURES

The technical solutions of the embodiments of the present utility model will be described clearly and completely with reference to the drawings of the embodiments below. Apparently, the described embodiments are merely part of the embodiments of the present utility model, but not all of them. All other embodiments obtained by a person skilled in the art based on the embodiments of the present utility model without creative efforts shall belong to the protective scope of the present utility model.

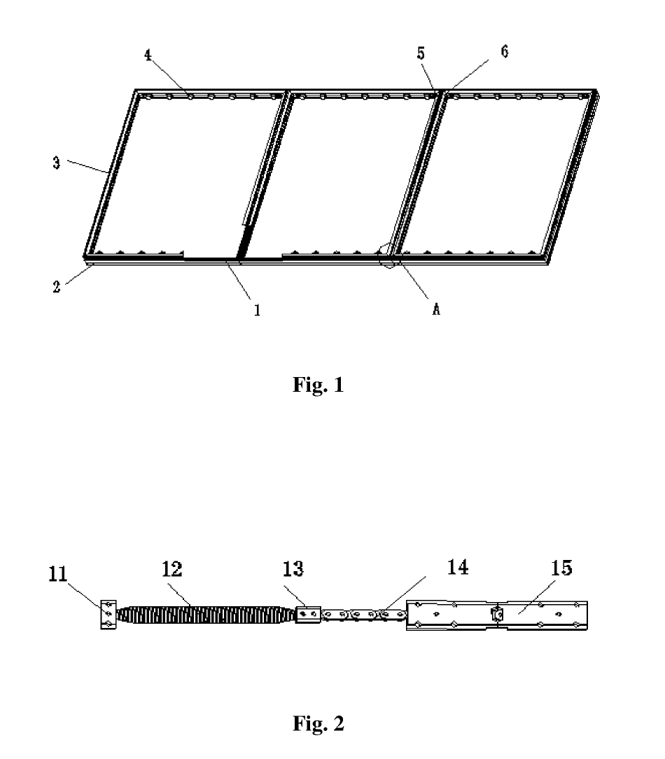

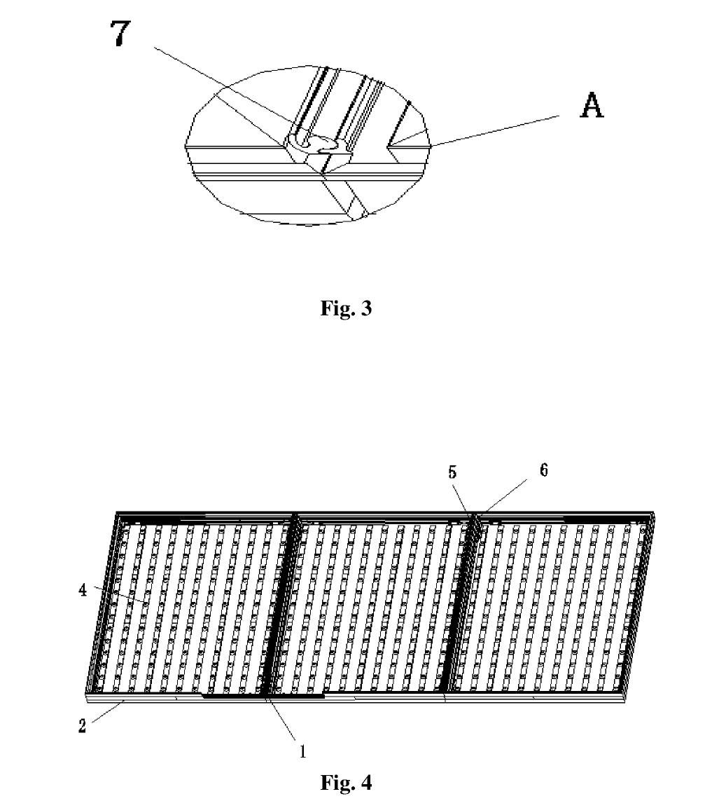

Referring to FIGS. 1-4, the present utility model provides a technical solution as follows. A foldable light box includes fourth profiles 2 which are assembled into a frame structure through profile connectors. The upper surface of the fourth profile 2 is connected with a first profile 3 and a foldable mechanism 1. The outer side surface of the fourth profile 2 at the left side of the frame structure is connected with the second profile 6. The outer side surface of the fourth profile 2 at the right side of the frame structure is connected with a third profile 5. The second profile 6 and the third profile 5 are meshed by a meshing mechanism 7. The inner side walls of the fourth profile 2 at the upper and lower ends of the frame structure are connected with lamp bead profiles. The inner side walls of the bead profiles are stuck with LED lamp bead parts 4 by a thermally conductive adhesive. The LED lamp bead parts 4 are electrically connected with an external power supply. U-shaped grooves are formed in the outer side walls of the second profile 6, the third profile 5 and the fourth profile 2.

In the present embodiment, preferably, the foldable mechanism 1 consists of a tension spring fixing block 11, a tension spring 12, a sliding block 13, a chain 14 and a chain fixing block 15, and is configured to assist the frame structure of the light box to fold. The operation is quick and convenient, so there is no need to disassemble the light box by a user. Therefore, the light box is more practical and competitive.

In the present embodiment, preferably, there is a set of meshing mechanism 7 respectively arranged on the upper and lower surfaces of the second profile 6 and of the third profile 5 when the second and third profiles are meshed. The meshing mechanism 7 consists of two limiting and fixing levers on the second profile 6 and the third profile 5. The meshing mechanisms 7 at the two sides of the bottom of the light box allow the frame structure of the light box to be easily folded from the front or the back, so that the light box is more flexible.

In the present embodiment, preferably, a reflective fabric is arranged on one side surface of the frame structure. A stretched fabric is arranged on the other side surface of the frame structure. The reflective fabric and the stretched fabric are embedded in the U-shaped grooves in the outer side walls of the second profile 6, the third profile 5 and the fourth profile 2 by a silica gel strip. There are patterns printed on the surface of the stretched fabric.

In addition, referring to FIG. 4, the LED lamp bead parts 4 in the present embodiment are stuck to the lamp bead profiles through a thermally conductive adhesive. The lamp bead profiles can be connected between two fourth profiles at the bottom of the frame structure through profile connectors to form a back lighting structure. Thus, the flexibility in use is improved.

The working principle of the foldable light box provided by the present utility model is as follows. The foldable light box is more convenient and safer to use. Generally, it does not change the using method of a traditional light box. Once the light box is connected with the external power supply, the LED lamp bead parts 4 can emit light. The stretched fabric and the reflective fabric stretch tightly under the impact of the silica gel strip to ensure the smooth pictures. There are different patterns printed on the surface of the stretched cloth, which meet different needs of the users. When in use, the foldable mechanism 1 and the meshing mechanism 7 cooperate with each other, so that the folding function of the entire light box is realized. As the size is reduced, the light box is more convenient to transport and place, needs less transportation cost and space, is easier to carry and display, and thus is more competitive. The light box can realize side lighting and back lighting, so that the flexibility in use is higher.

Although the embodiments of the present utility model have been shown and described, it will be understood by those skilled in the art that various changes, modifications, alternatives and variations may be made to these embodiments without departing from the principle and spirit of the present utility model. The scope of the present utility model is defined by the appended claims and equivalents thereof.

1. A foldable light box, comprising: four profile, which are assembled into a frame structure; an upper surface of the four profiles is connected with a first profile and a foldable mechanism; an outer side surface of the four profiles at a left side of the frame structure is connected with a second profile; the outer side surface of the four profiles at a right side of the frame structure is connected with a third profile; the second profile and the third profile are meshed with each other through a meshing mechanism; inner side walls of the four profiles at the upper and lower ends of the frame structure are connected with lamp bead profiles; inner side walls of the lamp bead profiles are stuck to LED lamp bead parts through a thermally conductive adhesive; the LED lamp bead parts are electrically connected; and U-shaped grooves are formed in the outer side walls of the second profile, the third profile and a fourth profile.

2. The foldable light box according to claim 1, wherein the foldable mechanism includes a tension spring fixing block, a tension spring, a sliding block, a chain and a chain fixing block.

3. The foldable light box according to claim 1, wherein the meshing mechanism comprises a set of meshing mechanisms respectively arranged on an upper surface and a lower surface of the second profile and the third profile when the second and third profiles are meshed.

4.-5. (canceled)
